(19) United States
(12) Patent Application Publication
(10) Pub. No.: US 2026/0025481 A1
(43) Pub. Date: Jan. 22, 2026

(54) DETERMINING SECURITY INTRUSIONS DURING VIRTUAL CONFERENCES

(71) Applicant: Zoom Video Communications, Inc., San Jose, CA (US)

(72) Inventor: Robert Jerome Graham, Waiblingen (DE)

(73) Assignee: Zoom Video Communications, Inc., San Jose, CA (US)

(21) Appl. No.: 18/778,638

(22) Filed: Jul. 19, 2024

(51) Int. Cl. H04N 7/15; H04N 7/14

(52) U.S. Cl. CPC H04N 7/157; H04N 7/147; H04N 7/152

(57) ABSTRACT

One example method includes receiving, during a virtual conference hosted by a virtual conference provider, one or more audio or video streams from one or more client devices connected to the virtual conference, each client device associated with a participant attending the virtual conference; providing, to a trained machine learning (“ML”) model, the received one or more audio or video streams to determine a potential security intrusion; in response to receiving an indication of a potential security intrusion from the trained ML model: generating an indication of the potential security intrusion; and providing the indication to one or more client devices of the one or more client devices.

### FIELD

The present application generally relates to virtual conferencing, and more particular relates to determining security intrusions during virtual conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for determining security intrusions during virtual conferences;

FIGS. 3A-3D show an example system for determining security intrusions during virtual conferences;

FIGS. 4A-4E show an example graphical user interface for determining security intrusions during virtual conferences;

FIG. 5 shows an example method for determining security intrusions during virtual conferences; and

FIG. 6 shows an example computing device suitable for use with example systems and methods for determining security intrusions during virtual conferences.

### DETAILED DESCRIPTION

Examples are described herein in the context of determining security intrusions during virtual conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Virtual conferencing, e.g., video conferencing, has become a conventional way for people to connect with each other, whether for personal or business reasons. To participate in a virtual conference, a person will use a computing device, like a laptop computer or smartphone, to run a virtual conferencing application and can then provide information needed to join the virtual conference, like a meeting identifier and a passcode. Once the user is connected to the virtual conference, they will be able to hear or see the other participants in the video conference via audio or video streams captured by the other participants computing devices. In addition, their own computing device will capture and provide audio or video streams to the other participants in the virtual conference.

However, as virtual conferencing becomes more prevalent, users may wish to use it for communications that are highly confidential or sensitive. For example, founders of a startup may engage with each other by virtual conferencing to discuss their innovations and business strategies. Similarly, government or military users may need to discuss highly sensitive subjects by virtual conference. However, while conventional virtual conferencing platforms may offer security features such as end-to-end (“E2E”) encryption to ensure only the participants in the virtual conference can receive and access exchanged video and audio streams, such sensitive conversations typically must be further secured by securing the environment in which each participant joins the virtual conference. For example, the founders of the startup may wish to ensure that discussions only happen in known environments, e.g., dedicated conference rooms or within the founders' own homes. Similarly, government or military personnel may be required to enter a specially built sensitive compartmented information facility (“SCIF”) and use virtual conferencing equipment vetted and installed in the SCIF.

However, SCIFs may be prohibitively expensive for most virtual conferencing participants or may not be logistically possible for certain participants, such as those who are stationed in remote or temporary facilities. Despite these difficulties, people may still need to communicate sensitive information by virtual conferencing.

To help a user determine whether their virtual conference remains secure enough to allow the exchange of confidential information, the user may request that the virtual conference operate in a secure mode, which instructs client software used by each participant to enable one or more sensors to determine the potential presence of unauthorized persons during the conference. For example, each client device may use its associated camera to capture video of the environment behind the respective participant and use a trained machine learning (“ML”) model to detect the presence of additional people in the background. It may also perform object detection and recognition on frames of the video to identify the presence of suspicious or prohibited items, such as personal smartphones, recording devices, or other electronic devices. In addition, the client device may use its associated microphone to capture audio from the participant's environment to detect the presence of other persons. To do so, the captured audio may be provided to another trained ML model to assess the number of speakers present in the environment or to detect sounds in the environment that indicate the presence of another person besides the participant. In addition, each client device may identify the specific devices used to capture audio and video and then verify that each is an authorized device.

If the output from one or more of the ML models, an object detection or recognition functionality, or other analytical functionality indicates the presence of a potential unauthorized person or device, it may output a notification to the user of the client device or it may transmit a notification to one or more other participants in the virtual conference indicating the presence of the person or object. In some examples, the client software may discontinue displaying video streams and audio streams received from the other participants until the issue is resolved. For example, the participant may remove the unauthorized person or object from the environment, or the additional person may be authenticated and authorized to participate in the conference. In some examples, the client software may entirely disconnect from the virtual conference. Thus, a user may be able to help determine the security of their own environment during a virtual conference and be assured that the other participants are similarly monitoring their own environments for potential unauthorized persons or devices. This may enable a user to establish relatively secure participation in a virtual conference without the need to prepare a specialized sanitized environment for the virtual conference.

This illustrative example is given to introduce the reader to the general subject matter discussed herein and the disclosure is not limited to this example. The following sections describe various additional non-limiting examples and examples of determining security intrusions during virtual conferences.

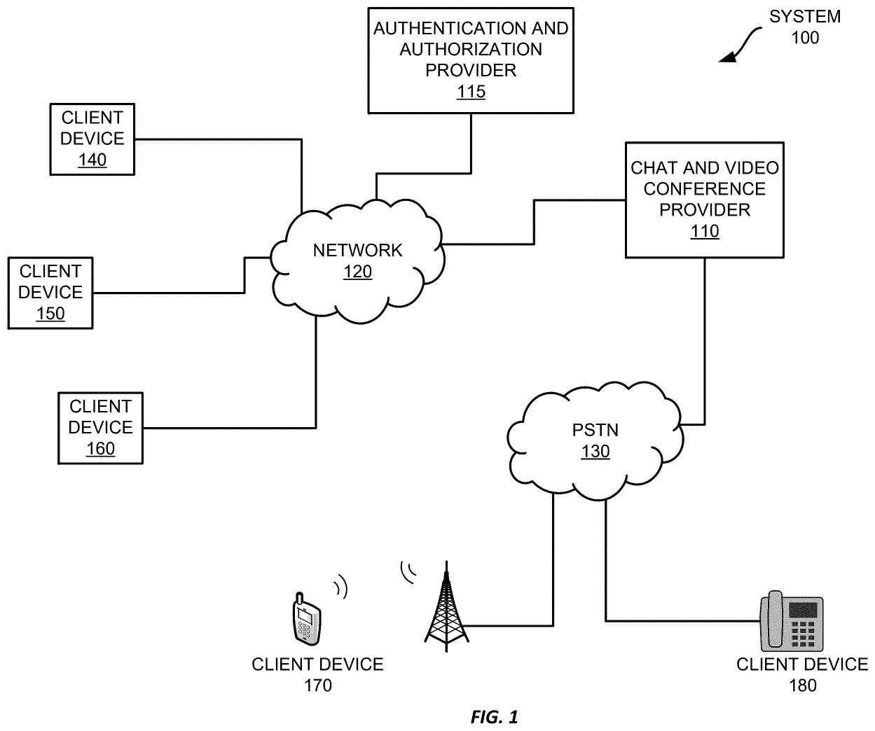

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

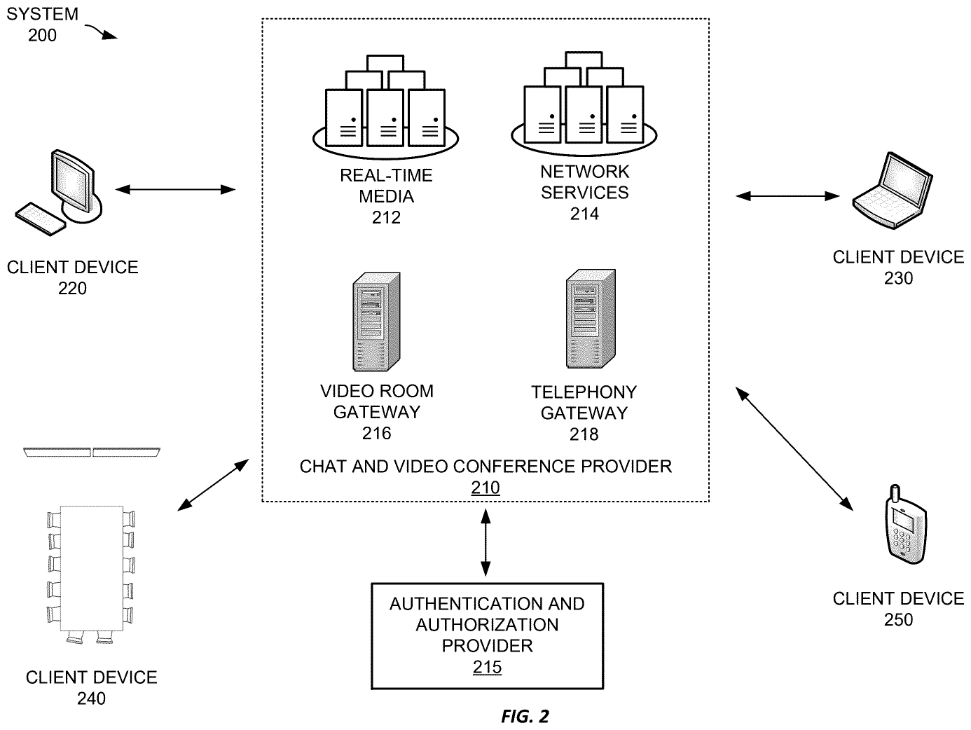

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

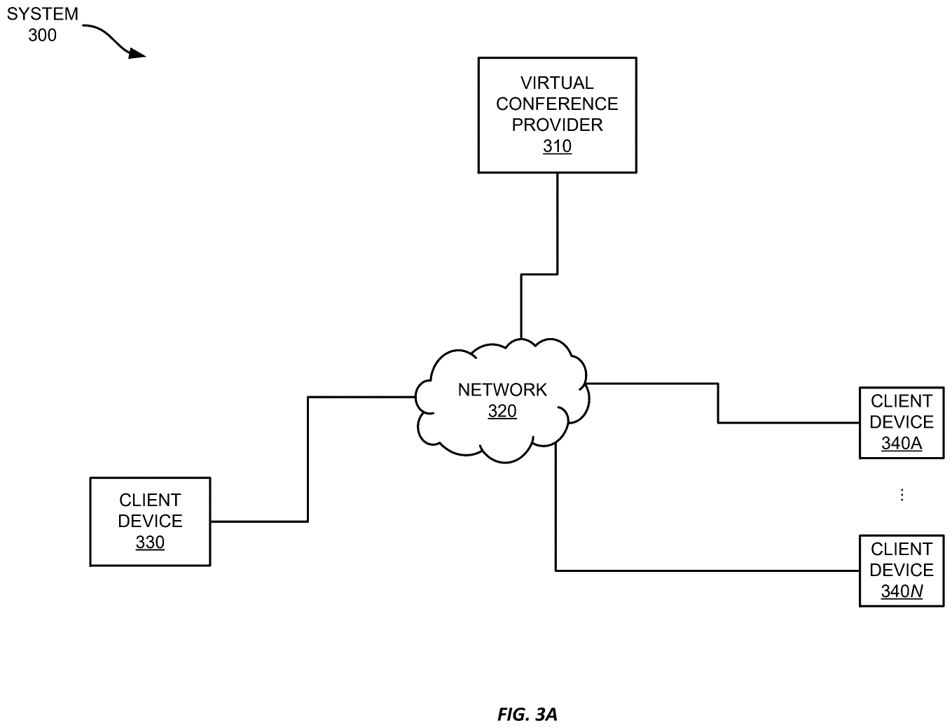

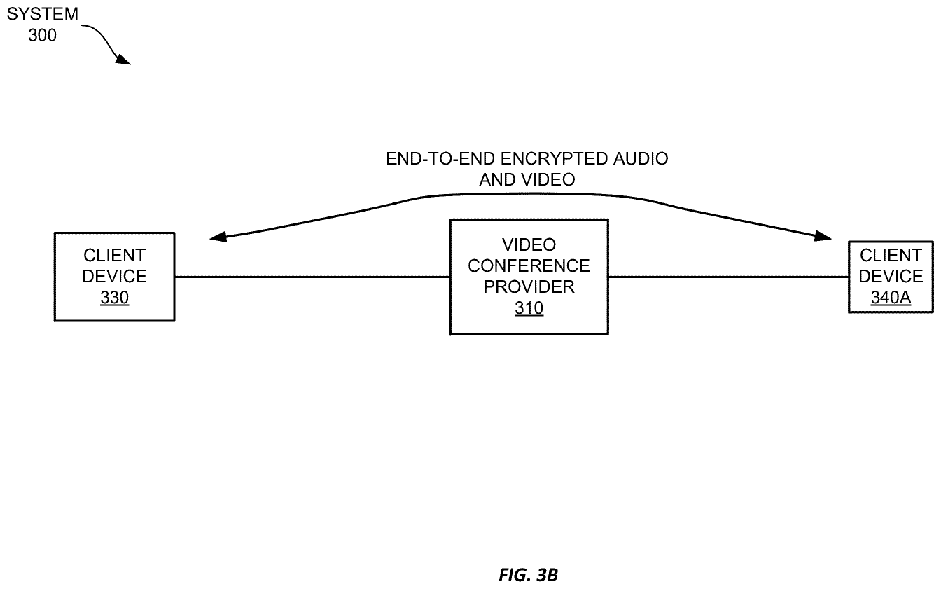

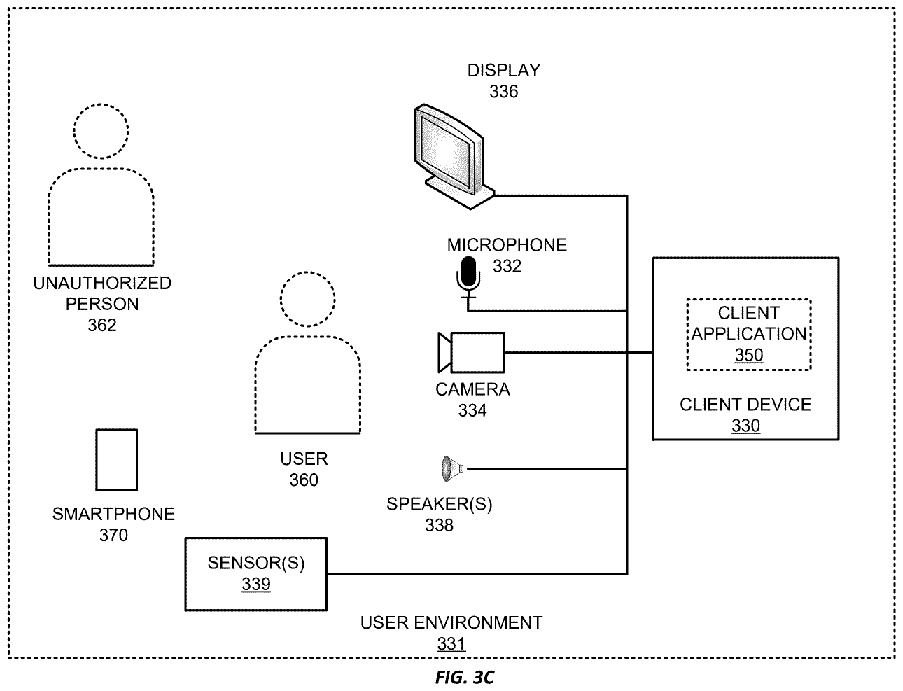

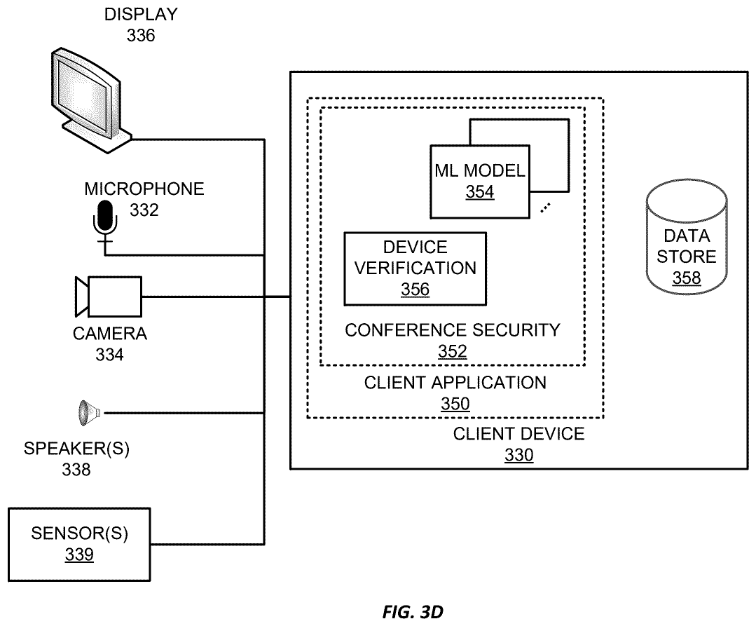

Referring now to FIG. 3A, FIG. 3A shows an example system 300 for determining security intrusions during virtual conferences. The system 300 shown in FIG. 3A includes a video conference provider 310 and multiple client devices 330, 340a-n that are connected to the video conference provider 310 via a network 320. In this example, the network 320 is the internet; however, any communications network or combination of communications networks may be employed. And while the system 300 is depicted as including multiple client devices 330, 340a-n, it should be appreciated that some example systems may not include any client devices at any particular time. Rather, the video conference provider 310 may be sufficient as a system for determining security intrusions during virtual conferences, to which one or more client devices 330, 340a-n may connect.

The client devices 330, 340a-n may connect to the virtual conference provider 310 to engage in virtual conferences, generally as discussed above with respect to FIGS. 1-2. However, while a conventional virtual conference may provide some level of security for the participant, such as by encrypting audio and video streams, the virtual conference provider 310 itself may have access to the cryptographic keys needed to access the unencrypted audio and video streams, such as to record the virtual conference at the request of the participants. But because the virtual conference provider may be an untrusted entity or may lack sufficient clearance or authorization to access subject matter discussed during a virtual conference, virtual conferences may be end-to-end encrypted (“E2E-encrypted”) so that only the participants have access to the cryptographic keys needed to access encrypted audio and video streams.

Referring to FIG. 3B, FIG. 3B shows the system 300 where two participants are engaged in an E2E-encrypted virtual conference hosted by the virtual conference provider 310. And while this example shows only two client devices participating in the virtual conference, any number of client devices may participate in an E2E-encrypted virtual conference.

In an E2E-encrypted video conference, each participant joins the video conference with their respective client device 330-340a and the host establishes a meeting key, e.g., a symmetric cryptographic key, that will be used to encrypt and decrypt the audio and video streams. Each of the participants also has their own respective public/private key pair that can be used to communicate with the respective participant and each participant's public key is published or distributed in any suitable manner, such as by registering it with a trusted entity or by generating a cryptographic signature using a private key and allowing the host or other participants to use a published copy of the public key to verify the signature.

Once each participant's public key has been verified, the host can securely distribute the meeting key to the participants by encrypting the meeting key using the participant's respective public keys. For example, the host may generate and send an encrypted message including the meeting key to each participant using the respective participant's public key. Upon receiving successfully decrypting the meeting key, the respective participants are then able to encrypt and decrypt meeting content.

In system 300 shown in FIG. 3B, client device 330 initially connects to the video conference provider 310 and requests that the video conference provider create a new meeting. Once the meeting is created, client device 330 is designated as the host of the meeting and establishes a meeting key to use to provide for E2E encryption in the meeting, but does not provide it to the video conference provider 310. Subsequently, a participant client device 340a joins the meeting and generates and provides a cryptographically signed message using its private key to the host client device 330, which verifies the message using the participant's public key. After verifying the public key, the host client device 330 encrypts the meeting key using the participant's public key and transmits it to the participant client device 340a, which decrypts the meeting key. Once the meeting key has been successfully received and decrypted by the participant client device 340a, it may begin transmitting encrypted audio and video using the meeting key.

In this example, each participant generates a per-stream encryption key by computing a new key using a non-secret stream ID for each data stream it transmits (e.g., audio and video), and uses the corresponding stream encryption key to encrypt its audio and video stream(s). The video conference provider receives the various encrypted streams, multiplexes them generally as described above with respect to FIGS. 1 and 2, and distributes them to the various participating client devices 330-340a. The respective client devices 330-340a can then use the meeting key to decrypt the incoming streams and view the content of the video conference.

However, as part of this process, the video conference provider 310 does not have access to the meeting key. Thus, the video conference provider 310 is unable to decrypt the various audio and video streams. But because the individual streams are separately received from the various participants, the video conference provider 310 is able to identify the source of each stream and therefore it can properly multiplex the streams for delivery to each participant.

Using E2E-encrypted virtual conferences can help ensure the security of a virtual conference between different participants. However, the encryption mechanism only prevents people from surreptitiously accessing the video and audio feeds using a client device that is not otherwise connected to the virtual conference. It does not protect against people who are physically present in the same location as someone participating in the virtual conference and can therefore see and here what is being discussed by viewing the participant's screen and hearing audio output by the participant's speakers.

Referring now to FIG. 3C, FIG. 3C illustrates an example client device 330 and the environment 331 it is operating within, which includes the user 360, an unauthorized person 362, and a smartphone 370 that is positioned on a piece of furniture in the user environment 331. During a virtual conference, the user 360 connects their client device 330 to the virtual conference, hosted by the virtual conference provider 310, using the client application 350 generally as discussed above. The microphone 332 and the camera 334 connected to the client device 330 capture audio and video streams, respectively, and provide them to the client application 350, which in turn transmits them to the virtual conference provider as a part of the virtual conference. In this example, the virtual conference is an E2E-encrypted virtual conference, so the client application 350 encrypts the received audio and video streams from the microphone 332 and camera 334 using the appropriate cryptographic keys before transmitting. In addition, as discussed above, the client application decrypts incoming audio and video streams from other participants before displaying them on the display 336 or speaker(s) 338. Thus, the audio and video streams exchanged during the virtual conference are secure from anyone who is able to obtain the encrypted streams. However, as can be seen, there are two potential security risks present in the user environment who are able to see and hear any audio or video output by the client device, as well as whatever the user 360 says or shares, such as electronic documents, during the virtual conference.

This example illustrates that securing a virtual conference includes more than securing the data while it is being transmitted via a computer network. In this case, the unauthorized person 362 and the smartphone 370 may capture information exchanged during the virtual conference, thereby compromising the confidentiality of that information. In some cases, the unauthorized person 362 or the smartphone 370 may be present without the user's knowledge. Alternatively, one or both (or multiple people or electronic devices) may be present with the user's knowledge, but without others in the conference realizing it. For example, the user may employ a virtual background as they participate, which may hide the user environment 331, except for the user's face. Thus, the user may allow unauthorized people into the environment 301 with the expectation that others in the virtual meeting will be unaware of their presence.

To help ensure the security of the user environment and determine when a security intrusion has occurred, the client application 350 can monitor incoming audio and video streams, as well as information received from other types of sensors 339, to detect the presence of potentially unauthorized person or devices. Suitable sensors 339 may include one or more motion detectors, thermal sensors, wireless access points, or other devices capable of detecting indications of persons or electronic devices present within an environment. Outputs from these sensors may be provided to the client application 350 to help determine security intrusions during virtual conferences.

In addition to the sensors 339 discussed above, other sensors may be used to verify the status of the client device itself. For example, a GPS receiver or other wireless positioning technology (e.g., cellular or WiFi trilateration techniques) may be used to determine the location of the client device 330, which may be used to determine whether the user's location is potentially unexpected or otherwise suspicious. For example, if the user 360 appears to be working from a public location, such as a library, or in a foreign country, the client application 350 at the client device 330 or another client device 340a or the virtual conference provider 310 may generate an indication that the user is in a potentially unauthorized location. In some examples, a user 360 may have a set of typical locations that are tracked by the client device 330 or by the host of the virtual conference. If the locationing sensor indicates the user is not at one of these typical locations, the client application 350 another user's client application may determine there has been a security intrusion, even if the user otherwise appears to be authorized.

Referring now to FIG. 3D, FIG. 3D illustrates the client device 330 of the system 300 and the client application 350 discussed above. In this example, the client application 350 enables the user 360 to connect with the virtual conference provider 310 and engage in virtual conferences, including E2E-encrypted virtual conferences. In addition, the client application 350 is configured with conference security functionality 352 for determining security intrusions during virtual conferences. In this example, the security functionality 352 includes multiple ML models 354, device verification functionality 358, and a data store 358 that may include information usable by the client application with respect to outputs received from the trained ML model(s) 354 or the device verification functionality 356. Each of the functionalities can individually determine security intrusions, but may also provide outputs that may be used synergistically to determine security intrusions. And while in this example, the conference security functionality 352 itself includes the ML models 354 and device verification functionality 356, in some examples, it may interact with one or more of such features hosted remotely, such as a remote server provided by a security service provider.

In this example, the client application 350 includes one or more trained ML models 354 that are configured to identify people within a video frame, recognize individual faces within a video frame, differentiate between different voices captured by a microphone (e.g., microphone 332), perform automatic speech recognition (“ASR”), and determine audio sources within an environment (e.g., user environment 331). However, any suitable trained ML models may be employed according to different examples.

Each trained ML model 354 accepts as input one or more video frames, captured audio, or information from one or more other sensors 339 connected to the client device 330 and generates a corresponding output. For example, a first trained ML 354 may be trained determine a number of people present in one or more video frames and output the number of people to the client application 350. Similarly, another trained ML model 354 may be trained to perform facial recognition on received video frames. As discussed above, other trained ML models 354 may be trained to determine a number of different voices within received audio or perform voice recognition on different voices within received audio. Similarly, one or more ML models may be trained to recognize speech patterns or movement patterns or mannerisms of particular people and may attempt to verify that a person who joins the meeting is who they are presenting to be by analyzing their speech pattern or movements during the meeting. If a deviation is detected, the client application 350 may determine a potential security intrusion. In addition, one or more trained ML models 354 may perform objection detection or recognition functionality to identify objects present within the user environment. One trained ML model may be trained to identify or recognize electronic device, while another may be trained to identify or recognize non-human animal, such as house pets. Such a trained ML model may be used by the client application 350 in conjunction with other sensors to determine whether a detected potential security intrusion relates to a dog or cat moving in the environment or to another person in the environment. Similarly, one or more ML models may be trained to detect people, animals, or other objects in video captured by a thermal imaging device, such as based on different temperature information visible in the captured video.

In addition to the trained ML model(s) 354, the client application 350 may employ device verification functionality 356 to determine whether electronic device connected to the client device 330 are authorized for use during a secure virtual conference. For example, the user may connect one or more microphones 332 and cameras 334 to the client device. They may have other peripherals attached as well, such as a keyboard, a mouse, one or more light sources, and so forth. The client application 350 may use the device verification functionality 356 to obtain information from each connected peripheral device and determine whether each peripheral device is authorized for use during a secure virtual conference. For example, the client application may obtain device identifiers, manufacturer information, device driver information, and version information from the respective peripheral devices or from the client device 330. It may then compare the device identifiers with information about authorized devices stored in the data store 358 or at a remote location. For example, the device identifiers and manufacturer information may be transmitted to the host's client device for verification, which may analyze them and respond with an authorization indication. Device driver information may be compared against verification for known device driver versions. For example, the device verification functionality may perform a hash function on a device driver file and compare the computed hash value with a known confirmed hash value for the particular device driver file and version. If the two hash values match, the device verification functionality 356 may output an indication of a match. If they do not, the device verification functionality 356 may output an indication of a mismatch. The client application 350 may then attempt to verify that every peripheral device is authorized for use during a secured virtual conference.

Because the state of the user environment 331 may change during the course of a virtual conference, the client application 350 may employ the trained ML models 354 and the device verification functionality 356 throughout the course of the entire conference to determine if any security intrusions occur. For example, before (or after) joining the conference, the client application 350 may provide audio and video streams, as well as information received from one or more sensors 339, to the trained ML models 354 to determine if any potentially unauthorized persons or devices are present in the user environment. Similarly, the client application 350 employs the device verification functionality 356 to verify that all devices connected to the client device are authorized. It may also verify that the client application 350 itself has not been tampered with, such as by hashing the client application's executable file or one or more library files and comparing the computed hashes with known valid hash values for each respective file. If the client application determines that no unauthorized persons and devices are present and that all connected peripherals and the client application 350 itself are authorized, the user may be joined the virtual conference. Otherwise, the user may be notified of the potential security intrusion so that they may take remedial action or they may be prevented from joining the virtual conference. For example, one trained ML model may be trained to recognize within a video frame whether a door or window into the user's environment has been left open. If so, the client application 350 can output a notification identifying the open door or window. When the ML model 354 determines that the door or window has been closed, the client application 350 may discontinue the notification and resume normal operation.

After the user joins the virtual conference, it continues to employ the trained ML models 354 and the device verification functionality 356 to monitor the user's environment for potential security intrusions. In some examples, it is configured to periodically send a message to the host or one or more other participants verifying that no security intrusions have been identified. However, if a potential security intrusion is determined, the client application may output a notification to the user 360 about the security intrusion. In some examples, the client application 350 may also transmit a notification to the host or one or more other participants about the potential security intrusion. Further, the client application 350 may take further action, such as muting received audio and video streams so that the user can no longer see or hear any activity within the virtual conference. In some examples, it may also terminate a connection to the virtual conference. If the user is able to remedy the determined security intrusion, the client application 350 may allow the user to resume participation in the virtual conference.

For example, if an additional person 362 is detected in a video stream received from a camera, the client application 350 may discontinue outputting audio and video streams received from other participants; however, the client application may continue transmitting audio and video streams captured by the microphone 332 and camera 334. The other participants may then be notified of the potential security intrusion and may be provided an option to authorize the additional person, which may involve provide information identifying the person, or to terminate the connection to the potentially compromised participant. In some examples, such a notification may only be provided to the host's client device or may involve the other participants voting regarding whether to allow the participant to remain in the meeting.

Alternatively, if multiple successive security intrusions have been determined, e.g., a threshold number of security intrusions have occurred (e.g., a raw number of intrusions or a number of intrusions over a predefined time period), the client application 350 may determine that the user environment is too insecure and may exit the virtual conference. Thus, the client application 350 is able to help ensure that the user environment remains secure throughout the virtual conference.

In some examples, the device verification functionality 356 may also receive information from other client devices attending or attempting to join a virtual conference. For example, the host of a virtual conference may receive device information from other participants attempting to join the virtual conference, which may be provided to the device verification functionality 356. The device verification functionality 356 may access a data store to determine whether the device being used by a particular user has previously been authorized. For example, each device may provide a unique device identifier or identifiers for various hardware or software components within the device, e.g., a version of the client application, a hash value for the executable file of the client application, a network adapter model and serial number, etc. The host (or other) client device may receive the information and verify whether the software version or hash value corresponds to an authorized version of the software. Similarly, the host or other client device may determine whether the device being used by the participant attempting the join the virtual conference has previously been authorized. If not, the client application of the device attempting the verification mya notify the user of the potentially unauthorized attempt to join the meeting. Doing so may further ensure the security of the virtual conference.

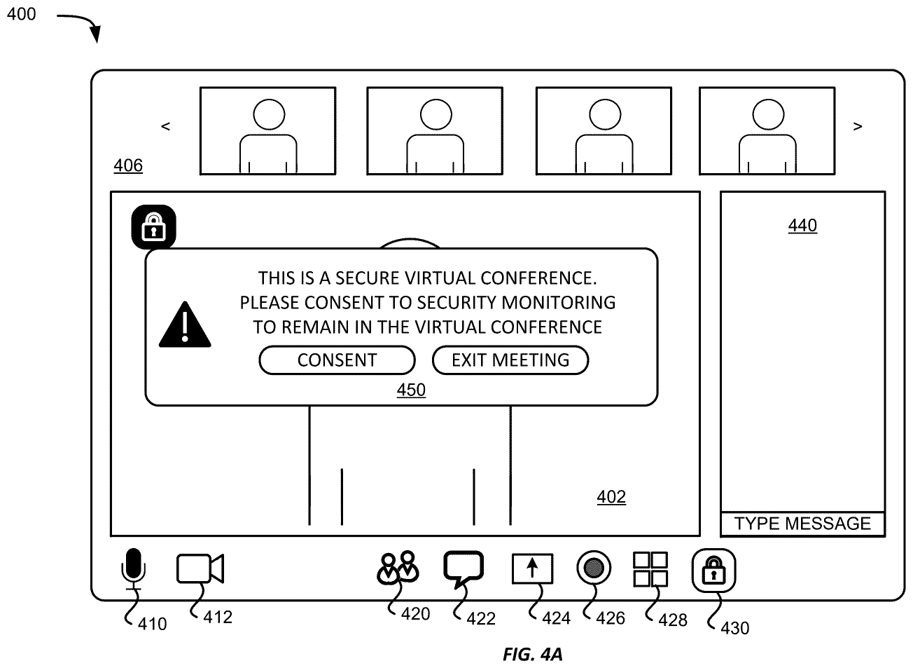

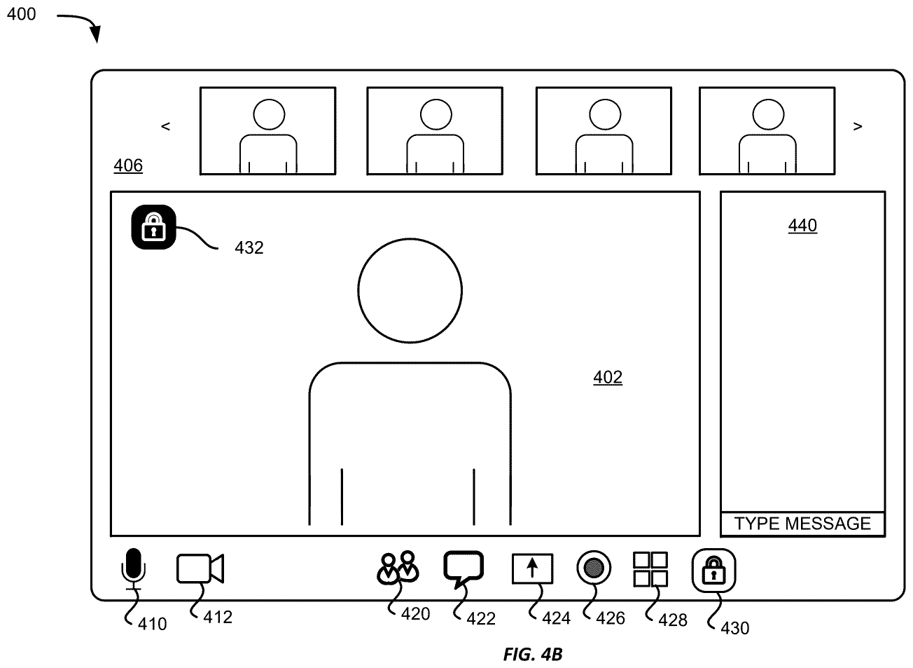

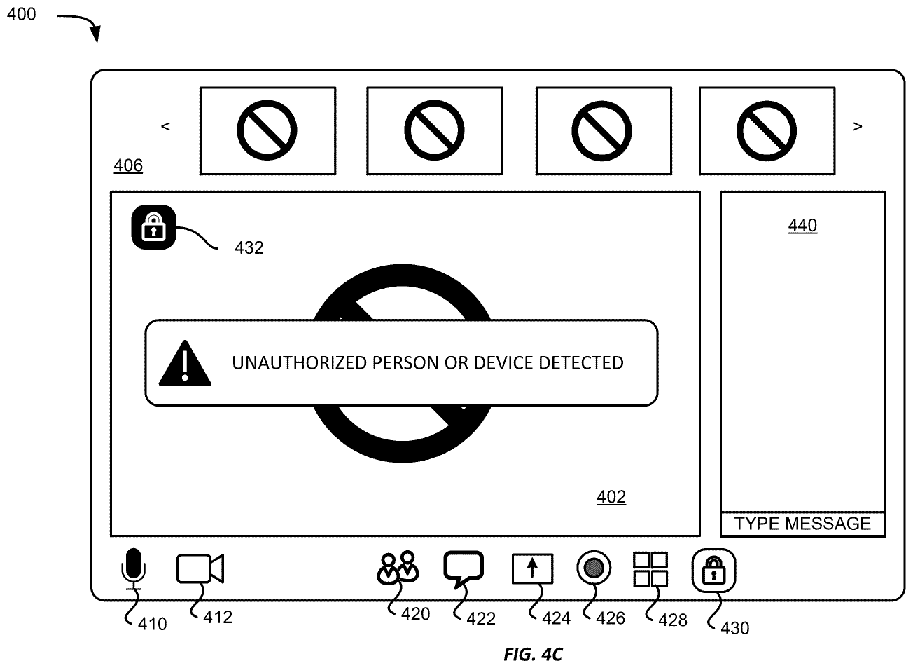

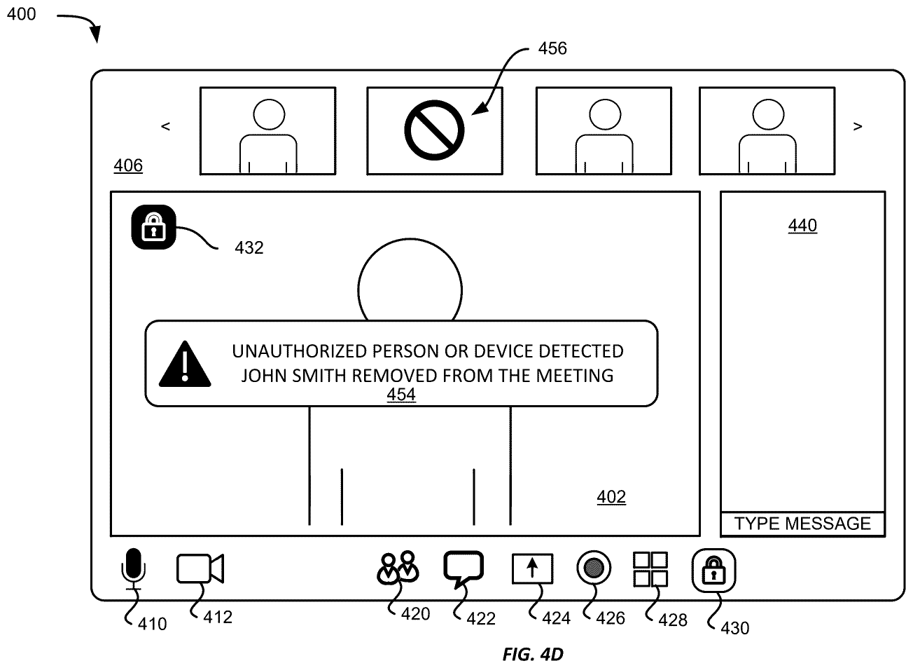

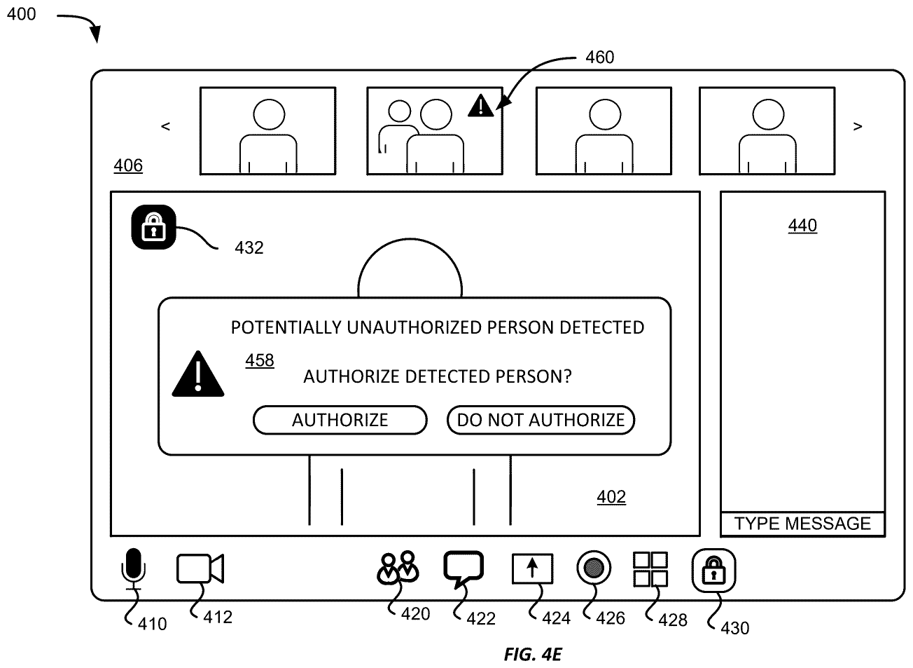

Referring now to FIG. 4A, FIG. 4A shows an example graphical user interface (“GUI”) for a client application that can determine security intrusions during virtual conferences. As discussed above, a client device, e.g., client device 330, executes a software client 350, which in turn displays the GUI 400 on the client device's display 336. In this example, the GUI 400 includes a speaker view window 402 that presents the current speaker in the virtual conference. Above the speaker view window 402 are smaller participant windows 406, which allow the participant to view some of the other participants in the virtual conference, as well as controls (“<” and “>”) to let the host scroll to view other participants in the virtual conference.

Beneath the speaker view window 402 are a number of interactive elements 410-430 to allow the participant to interact with the virtual conference software. Controls 410-412 may allow the participant to toggle on or off audio or video streams captured by a microphone or camera connected to the client device. Control 420 allows the participant to view any other participants in the virtual conference with the participant, while control 422 allows the participant to send text messages to other participants, whether to specific participants or to the entire meeting. Control 424 allows the participant to share content from their client device. Control 426 allows the participant toggle recording of the meeting, and control 428 allows the user to select an option to join a breakout room. Chat window 440 provides for the various participants to engage in text messaging during the virtual conference.

In this example, the GUI 400 also includes a control 430 to convert a virtual conference to a secure virtual conference. If the user selects the control 430, the client application 350 will transition to a secure virtual conference mode and use the trained ML models 354 and the device verification functionality 356 discussed above. In addition, it will transmit an indication to other participants in the virtual conference to operate in a secure virtual conference mode as well. In this example, the host client device is able to control operation of control 430 for the virtual conference, though in some examples a participant client device may transmit a request to the host client device to transition to a secure virtual conference, if the user of the participant client device activates control 430. In this example, the virtual conference has been established as a secure virtual conference and has output a notification 450 to the user of the client device 330 that the virtual conference is a secure virtual conference and that they must either consent to the environment monitoring discussed above with respect to FIGS. 3C-3D or exit the meeting. Such a notification 450 may be displayed by the GUI 400 at every client device connected to the virtual conference, including the client device that caused the transition to a secure virtual conference. Though in some examples, the conference may be configured as a secure virtual conference before it even begins. Thus, when the virtual conference begins, it begins as a secure virtual conference.

Referring to FIG. 4B, once the user consents to participating in the secure virtual conference, the notification 450 is removed and the user can interact with other participants by audio and video, or by sharing content such as documents, presentations, videos, and so forth. However, a security notification 432 is displayed to indicate that the virtual conference is a secure virtual conference.

Referring to FIG. 4C, FIG. 4C shows the GUI 400 after a potential security intrusion has been determined. In this example, a notification 452 is displayed within the user's GUI 400 and indicates a determined security intrusion within their own environment. For example, the client application 350 has detected the presence of a potentially unauthorized person or object, or an unauthorized peripheral connected to the client device 330. If a security intrusion is detected at a different client device, a similar notification may be displayed, but it may also identify which participant is experiencing the potential security intrusion. In this example, in addition to displaying then notification, the client application 350 has discontinued displaying video streams and outputting audio streams from the other participants to prevent unauthorized access to the content of the virtual conference. Similarly, the client application 350 may stop transmitting audio or video to the virtual conference. Though in some examples, the video or audio streams may be provided, which may allow the other participants to see or hear the potential security intrusion and understand the circumstances at the affect user environment 331. This may allow the other participants to decide whether the detected person should be authorized to participate in the virtual conference.

Referring to FIG. 4D, FIG. 4D shows the GUI 400 after a potential security intrusion has been detected at another client device and that corrective action has been taken. In this case, the notification 454 indicates that a potential security intrusion has been determined and that the affected participant has been disconnected from the virtual conference. A graphical indication 456 is provided as well to identify which participant has been removed. In this example, the host has manually removed the participant from the virtual conference, but in some examples, the host client device may automatically remove a participant after being notified of a potential security intrusion, or the participant's own client device may disconnect itself based on the determined security intrusion. Thus, the security of the virtual conference may be maintained, even if a potential security intrusion occurs.

Referring to FIG. 4E, FIG. 4E shows the GUI 400 after a potential security intrusion has been detected at another client device and a notification 458 of the potential intrusion has been provided to one or more other participants in the virtual conference, e.g., just the host or a subset of the participants. In addition, an indication 460 is provided within the video stream from the participant having the potential security intrusion. This may identify for the participant viewing the GUI 400 which participant's video stream to review and to identify the additional person present. In this example, the participant is provided with the option of authorizing the additional person or denying authorization. In this example, the participant is the host of the virtual conference and is the only participant to be provided with the option to authorize the detected additional person. If the host elects to authorize the detected person, the participant experiencing the potential security intrusion is allowed to remain in the meeting and receive and view video streams from the other participants. If multiple participants receive the option to authorize, they may each select an appropriate option. In some examples, if multiple participants respond, if all indicate the additional person should be authorized, the video conference may proceed normally and the detected person may be authorized to participate. However, if less than all of the participants agree to authorize the additional person, the additional person is not authorized and the participant where the additional person is located may be disconnected from the virtual conference. In some examples, if a threshold number of participants agree to authorize the additional participant, the additional participant may be authorized and the virtual conference may continue. Still other approaches may be employed in some examples.

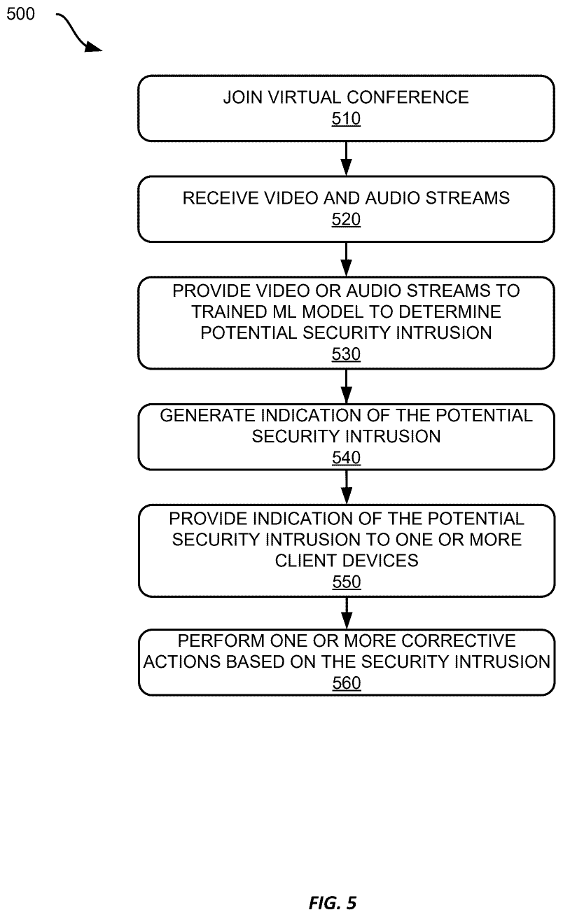

Referring now to FIG. 5, FIG. 5 shows an example method 500 for determining security intrusions during virtual conferences. The example method 500 will be described with respect to the system shown in FIGS. 3A-3D and the GUI shown in FIGS. 4A-4D; however, any suitable system or GUI according to this disclosure may be employed.

At block 510, a client device 330 joins a virtual conference hosted by a virtual conference provider, generally as described above with respect to FIGS. 1 and 2. In this example, the host of the virtual conference has configured it to be a secure virtual conference, which in this example enables E2E encryption for the virtual conference, generally as described above with respect to FIG. 3B. In addition, each client device executes its respective client application, which in response to the virtual conference being configured as a secure virtual conference, enables its conference security functionality 352.

While in this example, the host of the virtual conference has configured it to be a secure virtual conference, in some examples any participant may activate the control 430 to configure the virtual conference as a secure virtual conference, which may then cause the client application 350 to transmit an indication to the other client devices connected to the virtual conference that the virtual conference will be converted to a secure virtual conference. The client applications may then display the notification 450 discussed above with respect to FIG. 4A. In some examples, selecting the security control 430 may instead transmit an indication to the host client device requesting that the virtual conference be converted to a secure virtual conference. The host may then decide whether to accept or deny the request.

In response to the virtual conference being configured as a secure virtual conference, one or more settings in the client application may be modified to help ensure the security of the meeting. For example, the client application may disable background images or video or audio filters. In some example, the client application may disable controls 410, 412 to prevent the user from muting their audio or disabling their video. In some examples, the virtual conference may be automatically recorded if it is configured as a secure virtual conference. Such a setting may enable a post-hoc review of the recording to determine if any security intrusions occurred but were not detected or to determine the identities of any persons identified in the video, but were not recognized by the conference security functionality.

At block 520, the client application receives one or more audio or video streams from one or more client devices connected to the virtual conference generally as discussed above with respect to FIGS. 1-2 and 3B as well as one or more audio or video streams captured by the client device's own camera(s) and microphone(s). In this example, each client device has a camera and microphone to enable the respective user to communicate with others within the virtual conference, though in some examples, a client device may not employ a camera. In this example, in response to the virtual meeting being configured as a secure virtual meeting, each client application activates its connected camera and microphone, even if the user mutes their audio or video stream to prevent it from be transmitted to the other participants in the virtual conference. This enables the client application to capture audio and video of the user environment 331 for analysis by the client application's conference security functionality 352. The user may be provided with an indication that audio and video are still being captured, even if they are not being provided to the other participants.

At block 530, the client application provides one or more audio or video streams to the conference security functionality 352 generally as described above with respect to FIG. 3D. In this example, the client application 350 provides all audio and video streams captured by the client devices own camera(s) and microphone(s) to the conference security functionality. However, in some examples, processing requirements for the conference security functionality may limit the total number of streams that the conference security functionality can analyze substantially in real-time. Thus, the client application 350 may select one or more streams to exclude from the analysis. In this example, the client application identifies the primary audio and video streams (those streams that are provided to the other participants in the virtual conference) as streams for analysis, while selecting up to a maximum supported number of other audio or video streams for analysis. In addition to the client's own audio or video streams, the client application may provide one or more audio or video streams received from other client devices, or device information received from one or more other client devices, to its own conference security functionality to monitor the other user environments for potential security intrusions. Such functionality may be desirable if another user is not well known to the participants in the virtual conference or if the client device used by the other participant(s) are less capable and unable to provide sufficient processing capabilities to perform the conference security functionality 352 during the virtual conference.

In many examples, a client device may only have one connected camera and one connected microphone, which supply audio and video streams for distribution to other participants in the virtual conference as well as to the conference security functionality 352. However, in some examples, a client device may have multiple cameras or microphones available and may enable some or all of such available devices. The user may select the devices to use as the primary audio and video capture devices to distribute audio and video to the virtual conference as well as to the conference security functionality 352. However, the other available cameras or microphones may capture and provide audio or video streams to the conference security functionality 352. These additional capture devices may provide additional input streams that may be used to determine any potential security intrusions. In addition, as discussed above with respect to FIG. 3D, the client device may have other sensors 339 connected to it that may provide streams of sensor information to the client application 350. The client application 350 may then provide those streams of sensor information to the conference security functionality 352.

The conference security functionality 352 receives the audio and video streams provided by the client application 350 and inputs them into one or more of the available ML models 354. For example, multiple ML models 354 may provided to analyze video streams for different types of security intrusions, such as identifying a number of people visible or audible in a video or audio stream, respectively, recognizing one or more people or objects visible in a video stream, recognizing different audio sources present in an audio stream, and so forth. Thus, each video or audio stream received may be provided to one or more ML models 354. Moreover, the conference security functionality 352 may instantiate multiple copies of the same ML model to accommodate analysis of multiple different streams of the same type. For example, if three video streams are received and the conference security functionality 352 employs two different ML models to analyze video-one to identify people present in the video stream and the other to recognize objects in the video stream-the conference security functionality 352 may instantiate three of each ML model, one for each received video stream. As discussed above, this can require significant processing or memory capabilities, thus the client application may configure the conference security functionality 352 according to the capabilities of the client device 330.

In addition to providing audio and video streams to the conference security functionality 352, the client application also obtains information for one or more devices connected to the client device 330, generally as discussed above with respect to FIG. 3D. For example, the client application 350 may obtain device identifiers, manufacturer information, version information, driver information and so forth and provide the obtained information to the conference security functionality 352, which can then employ the device verification functionality 356 to determine whether any connected devices have not been authorized for use during a secure virtual conference. If one or more unauthorized devices are detected, the device verification functionality 356 may output an identification of the unauthorized device(s) to the conference security functionality 352, which may take action as discussed in more detail below.

In some examples, some ML models 354 may only be employed if the output of another ML model 354 indicates a potential security intrusion. For example, if a video stream from the camera 334 is provided to an ML model 354 trained to determine a number of people in a video frame and the ML model 354 outputs that two people appear to be visible in the video frame, the conference security functionality 352 then provide the video frame to a second ML model 354 to trained to recognize the identity of people within a video frame. The second ML model 354 may then output an indication of the recognized entities within the video frame, or if any entities are not recognized. If one or more of the recognized entities are not identified as being authorized to attend the virtual conference, or if any entities are not recognized, the method 500 may proceed to block 540. However, if all of the recognized entities are recognized, the method 500 may not proceed to block 540 at that time. Alternatively, in some examples, other participants may be provided with the option to determine whether to authorize the additional entities, such as described above with respect to FIG. 4E.

Similarly, if an audio stream is provided to an ML model and multiple voices are identified, the conference security functionality 352 may then provide the audio stream to a second ML model to recognize the different voices present in the audio stream. If all of the voices are recognized as belonging to authorized persons, the method 500 may not proceed to block 540. However, if one or more voices are either not recognized or recognized as belonging to an unauthorized person, the method may proceed to block 540.

In some examples, one or more ML models 354 may output a binary indication of a potential security intrusion, e.g., more than one person was recognized in a video stream; however, in some examples, one or more ML models 354 may output a confidence value associated with a potential security intrusion. For example, an ML model may perform object recognition on a video frame and indicate a confidence that an unauthorized object, such as a smartphone or other recording device, is identified in the user environment 331. If the confidence satisfies a predetermined threshold, the method may proceed to block 540. Similarly, an ML model may output a confidence that multiple voices were identified in the user environment 331, and if the confidence satisfies a predetermined threshold, the method may proceed to block 540.

Further in some examples, outputs from different ML models may contradict each other, or one output may override another ML model's output. For example the conference security functionality 352 may obtain outputs from multiple ML models 354 and apply one or more rules or a subsequent trained ML model to determine whether the outputs indicate a potential security intrusion. For example, a motion detector may provide a signal indicating movement within the user environment, while a second ML model may recognize the presence of a cat in one or more video frames. The conference security functionality 352 may employ an ML model 354 to determine a relationship between the detected movement and the identified cat and determine that no security intrusion has occurred.

It should be appreciated that block 530 may be performed continuously throughout the virtual conference. Thus, while a person may initially be verified as being an authorized attendee, such as via speech or video analysis, if they begin to deviate during the course of the meeting, their verification may be flagged as being suspicious or a potential security intrusion, such as to the host of the virtual conference.

At block 540, the conference security functionality 352, in response to receiving an indication of a potential security intrusion from a trained ML model, may generate an indication of a potential security intrusion. In this example, the one or more ML models 354 may output indications that an unauthorized person may be present in the user environment 331 or that the user environment 331 may not be secure. For example, as discussed above, one or more ML models 354 may determine that an additional person (or persons) besides the user 360 are present in the user environment 331 or that the additional person (or persons) is not recognized as being authorized to attend the virtual conference. In response to determining that the additional person is present, the conference security functionality 352 may generate an indication of a potential security intrusion based on the presence of the unauthorized person or persons. The indication may identify the basis for the determined security intrusion, e.g., an unauthorized person is present, and an indication of the user environment 331 that has the determined security intrusion, e.g., the user's name. In some examples, other information may be provided, such as the identity of the unauthorized person or persons, if available, or the time at which their presence was detected.

At block 550, the client application 350 provides the indication of the potential security intrusion to one or more client devices. In this example, the client application 350 provides the indication to the user's own client device 330, which may then output a notification within the GUI 400 of the client application 350, such as shown in FIG. 4C. In some examples the indication may be provided to the host client device, which may similarly display a notification to the host of the virtual conference. The host may then decide whether to take any corrective action. Further, the indication may be provided to all client devices connected to the virtual conference to inform all participants of the potential security intrusion.

At block 560, the client device 330 performs one or more corrective actions. In this example, if the client application 350 determines a security intrusion within its user's environment 331, it may disable incoming audio and video streams or stop outputting such incoming audio and video streams. In some examples, the client application may disconnect itself from the virtual conference. In an example where the client device receives an indication of a potential security intrusion from another client device, the client application may mute its audio or video streams to prevent them from being shared with the client device experiencing the security intrusion, or it may pause transmitting audio or video streams to that client device. In some examples, it may provide an option to authorize the person detected, or authorize the particular client experiencing the potential security intrusion to remain in the virtual conference, such as discussed above with respect to FIG. 4E. In some examples, the host client device may automatically disconnect the client device experiencing the security intrusion from the virtual conference or it may generate a new meeting key for the meeting, but only distribute it to the client devices that did not experience the security intrusion, thereby preventing the potentially compromised client device from decrypting any audio or video streams. In some examples, other client devices may discontinue providing their audio or video streams to other participants, or the host client device may instruct the virtual conference provider to stop providing audio and video streams to the client device having the potential security intrusion.

The description of the method 500 in FIG. 5 has been with respect to a particular order of events; however, it should be appreciated that because the method 500 is performed in real-time to monitor live video and audio streams, different blocks may occur in different orders or may occur concurrently with each other. For example, the client application 350 may continuously perform block 530 while audio and video streams are received, and may perform blocks 540-560 concurrently with the continued monitoring of video and audio streams at block 530. Further, while this example is performed in real-time during a virtual conference, in some examples, a recording of a virtual conference may be processed by the client application to determine any potential security intrusions that may have occurred. If any such security intrusions are detected, one or more notifications may be provided to the user performing the review, similarly to those shown in FIGS. 4C-4D despite not occurring during an on-going virtual conference.

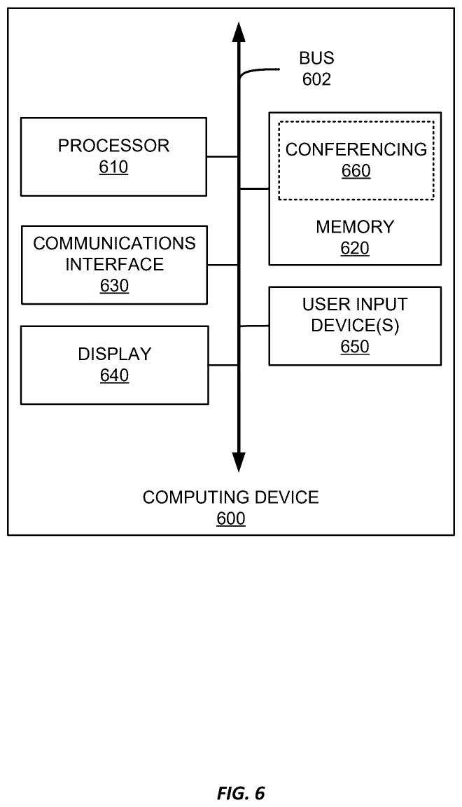

Referring now to FIG. 6, FIG. 6 shows an example computing device 600 suitable for use in example systems or methods for determining security intrusions during virtual conferences according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for determining security intrusions during virtual conferences according to different examples, such as part or all of the example method 500 described above with respect to FIG. 5. Suitable example computing devices 600, such as user client devices, may also include one or more user input devices 650, such as a keyboard, mouse, touchscreen, microphone, etc., to accept user input. The computing device 600 also includes a display 640 to provide visual output to a user. In addition, the computing device 600 includes client application 350, such as discussed above with respect to FIGS. 3A-3D.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, during a virtual conference hosted by a virtual conference provider, one or more audio or video streams from one or more client devices connected to the virtual conference, each client device associated with a participant attending the virtual conference;
providing, to a trained machine learning (“ML”) model, the received one or more audio or video streams to determine a potential security intrusion;
in response to receiving an indication of a potential security intrusion from the trained ML model:
generating an indication of the potential security intrusion; and
providing the indication to one or more client devices of the one or more client devices.

2. The method of claim 1, wherein the potential security intrusion is a presence of a potential unauthorized participant.

3. The method of claim 2, further comprising:
recognizing, using the trained ML model, a first participant visible in a first video stream of the one or more video streams; and
determining the first participant is authorized to attend the virtual conference.

4. The method of claim 3, further comprising:
recognizing, using the trained ML model, a second participant visible in the first video stream;
determining the second participant is not authorized to attend the virtual conference.

5. The method of claim 4, wherein recognizing the second participant visible in the first video stream comprises determining a second person is visible in the first video stream and failing to determine an identity of the second person.

6. The method of claim 1, further comprising:
recognizing, using the trained ML model, a first participant audible in a first audio stream of the one or more audio streams; and
determining the first participant is not authorized to attend the virtual conference.

7. The method of claim 1, wherein the receiving and the providing are performed by a first client device of the one or more client devices, and further comprising:
responsive to receiving an indication that the virtual conference is a secure virtual conference:
disabling, by the first client device, a virtual background based on the indication; and
determining that a camera and a microphone connected to the first client device are pre-authorized to provide video and audio streams, respectively, to the virtual conference.

8. The method of claim 1, wherein providing the received one or more audio or video streams comprises transmitting the received one or more audio or video streams to a remote computing device to input into the trained ML model.

9. A system comprising:
a communications interface;
a non-transitory computer-readable medium; and
one or more processors configured to execute processor-executable instructions stored in the non-transitory computer-readable medium to:
receive, during a virtual conference hosted by a virtual conference provider, one or more audio or video streams from one or more client devices connected to the virtual conference, each client device associated with a participant attending the virtual conference;
provide, to a trained machine learning (“ML”) model, the received one or more audio or video streams to determine a potential security intrusion;
in response to receiving an indication of a potential security intrusion from the trained ML model:
generate an indication of the potential security intrusion; and
provide the indication to one or more client devices of the one or more client devices.

10. The system of claim 9, wherein the potential security intrusion is a presence of a potential unauthorized participant.

11. The system of claim 10, wherein the one or more processors are configured to execute further processor-executable instructions stored in the non-transitory computer-readable medium to:
recognize, using the trained ML model, a first participant visible in a first video stream of the one or more video streams; and
determine the first participant is authorized to attend the virtual conference.

12. The system of claim 11, wherein the one or more processors are configured to execute further processor-executable instructions stored in the non-transitory computer-readable medium to:
recognize, using the trained ML model, a second participant visible in the first video stream;
determine the second participant is not authorized to attend the virtual conference.

13. The system of claim 12, wherein the one or more processors are configured to execute further processor-executable instructions stored in the non-transitory computer-readable medium to determine a second person is visible in the first video stream and failing to determine an identity of the second person.

14. The system of claim 9, wherein the one or more processors are configured to execute further processor-executable instructions stored in the non-transitory computer-readable medium to:
obtain location information from a sensor associated with the client device; and
determine a potential security intrusion based on the location information.

15. The system of claim 9, wherein the receiving and the providing are performed by a first client device of the one or more client devices, and wherein the one or more processors are configured to execute further processor-executable instructions stored in the non-transitory computer-readable medium to:
responsive to receiving an indication that the virtual conference is a secure virtual conference:
disable, by the first client device, a virtual background based on the indication; and
determine that a camera and a microphone connected to the first client device are pre-authorized to provide video and audio streams, respectively, to the virtual conference.

16. The system of claim 9, wherein the one or more processors are configured to execute further processor-executable instructions stored in the non-transitory computer-readable medium to transmit the received one or more audio or video streams to a remote computing device to input into the trained ML model.

17. A non-transitory computer-readable medium comprising processor-executable instructions configured to cause one or more processors to:
receive, during a virtual conference hosted by a virtual conference provider, one or more audio or video streams from one or more client devices connected to the virtual conference, each client device associated with a participant attending the virtual conference;
provide, to a trained machine learning (“ML”) model, the received one or more audio or video streams to determine a potential security intrusion;
in response to receiving an indication of a potential security intrusion from the trained ML model:
generate an indication of the potential security intrusion; and
provide the indication to one or more client devices of the one or more client devices.

18. The non-transitory computer-readable medium of claim 17, wherein the potential security intrusion is a presence of a potential unauthorized participant.

19. The non-transitory computer-readable medium of claim 18, further comprising processor-executable instructions configured to cause the one or more processors to:
recognize, using the trained ML model, a first participant visible in a first video stream of the one or more video streams; and
determine the first participant is authorized to attend the virtual conference.

20. The non-transitory computer-readable medium of claim 19, further comprising processor-executable instructions configured to cause the one or more processors to:
recognize, using the trained ML model, a second participant visible in the first video stream;
determine the second participant is not authorized to attend the virtual conference.
